(19) United States
(12) Patent Application Publication
(10) Pub. No.: US 2025/0234011 A1
(43) Pub. Date: Jul. 17, 2025

(54) MULTI-LAYER CODING FOR HYBRID MACHINE-HUMAN CONSUMPTION

(71) Applicant: Tencent America LLC, Palo Alto, CA (US)

(72) Inventors: Xin ZHAO, San Jose, CA (US); Shan LIU, San Jose, CA (US)

(73) Assignee: Tencent America LLC, Palo Alto, CA (US)

(21) Appl. No.: 19/026,097

(22) Filed: Jan. 16, 2025

Related U.S. Application Data
(60) Provisional application No. 63/621,755, filed on Jan. 17, 2024.

(51) Int. Cl. H04N 19/172; H04N 19/132; H04N 19/167; H04N 19/31; H04N 19/33; H04N 19/513

(52) U.S. Cl. CPC H04N 19/172; H04N 19/132; H04N 19/167; H04N 19/31; H04N 19/33; H04N 19/521

(57) ABSTRACT

Some aspects of the disclosure provide a method of video decoding. For example, a coded video bitstream is received. The coded video bitstream includes coded information of a video using multi-layer coding. The coded information includes first coded information corresponding to first coded pictures of a first layer serving for a machine task, and second coded information corresponding to second coded pictures of a second layer serving for a human consumption. A consumption type is determined from at least the machine task and the human consumption. Based on the consumption type, at least a reconstructed picture is reconstructed according to at least one of the first coded information and/or the second coded information.

### INCORPORATION BY REFERENCE

The present application claims the benefit of priority to U.S. Provisional Application No. 63/621,755, “MULTI-LAYER CODING FOR HYBRID MACHINE-HUMAN CONSUMPTION” filed on Jan. 17, 2024. The entire disclosure of the prior application is hereby incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. For example, a coded video bitstream is received. The coded video bitstream includes coded information of a video using multi-layer coding. The coded information includes first coded information corresponding to first coded pictures of a first layer serving for a machine task, and second coded information corresponding to second coded pictures of a second layer serving for a human consumption. A consumption type is determined from at least the machine task and the human consumption. Based on the consumption type, at least a reconstructed picture is reconstructed according to at least one of the first coded information and/or the second coded information.

Some aspects of the disclosure provide a method of video encoding. For example, first coded information is generated. The first coded information corresponds to first coded pictures of a first layer in a multi-layer coding of a video, the first layer serves for a machine task. Second coded information is generated. The second coded information corresponds to second coded pictures of a second layer in the multi-layer coding of the video, the second layer serves for a human consumption. A coded video bitstream for the video is generated, the coded video bitstream includes at least the first coded information and the second coded information.

According to an aspect of the disclosure, a method of processing visual media data is provided. In the method, a conversion between a visual media file and a bitstream of visual media data is performed according to a format rule. In an example, the bitstream includes coded information of a video using multi-layer coding, the coded information includes first coded information corresponding to first coded pictures of a first layer serving for a machine task, and second coded information corresponding to second coded pictures of a second layer serving for a human consumption. The format rule specifies that: a consumption type is determined from at least the machine task and the human consumption; and based on the consumption type, at least a reconstructed picture is reconstructed according to at least one of the first coded information and/or the second coded information.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIG. 4 shows a block diagram of a video processing system in a machine scenario in some examples.

FIG. 5 shows a diagram of multi-layer coding in some examples.

FIG. 6 shows a flow chart outlining a decoding process according to some aspects of the disclosure.

FIG. 7 shows a flow chart outlining an encoding process according to some aspects of the disclosure.

FIG. 8 is a schematic illustration of a computer system in accordance with an aspect.

### DETAILED DESCRIPTION

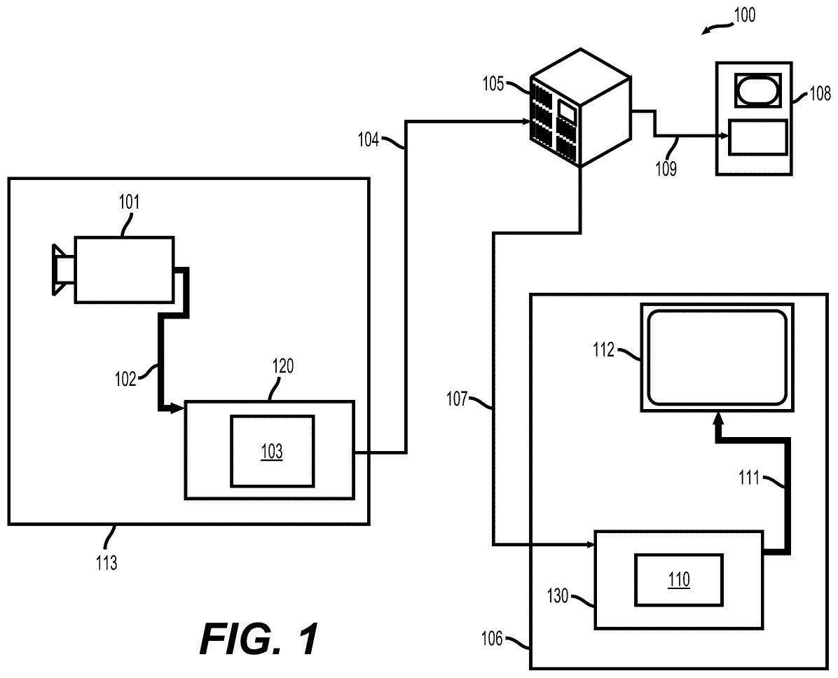

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

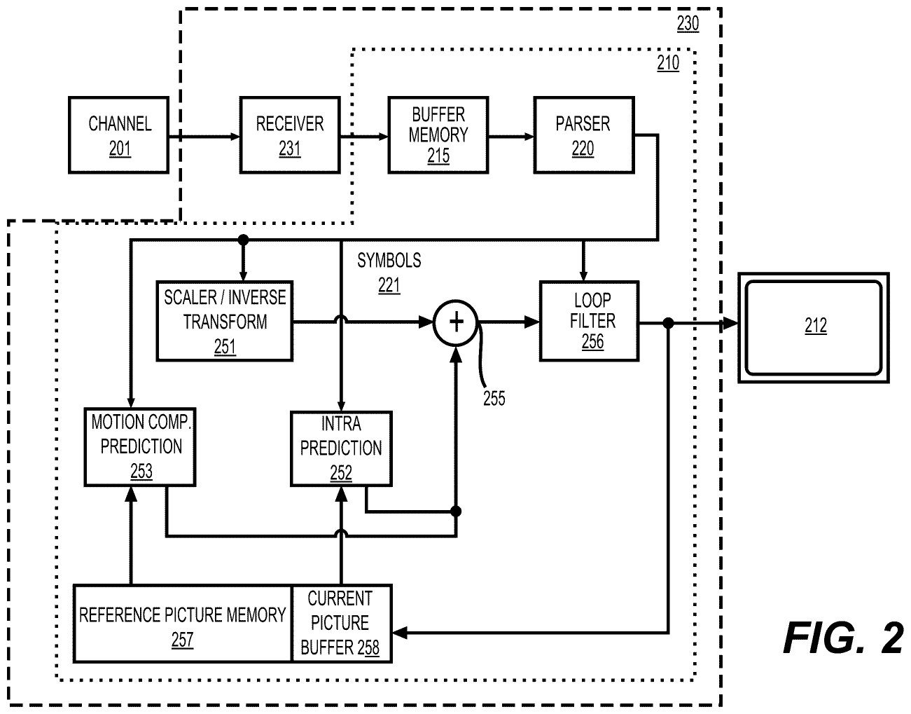

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

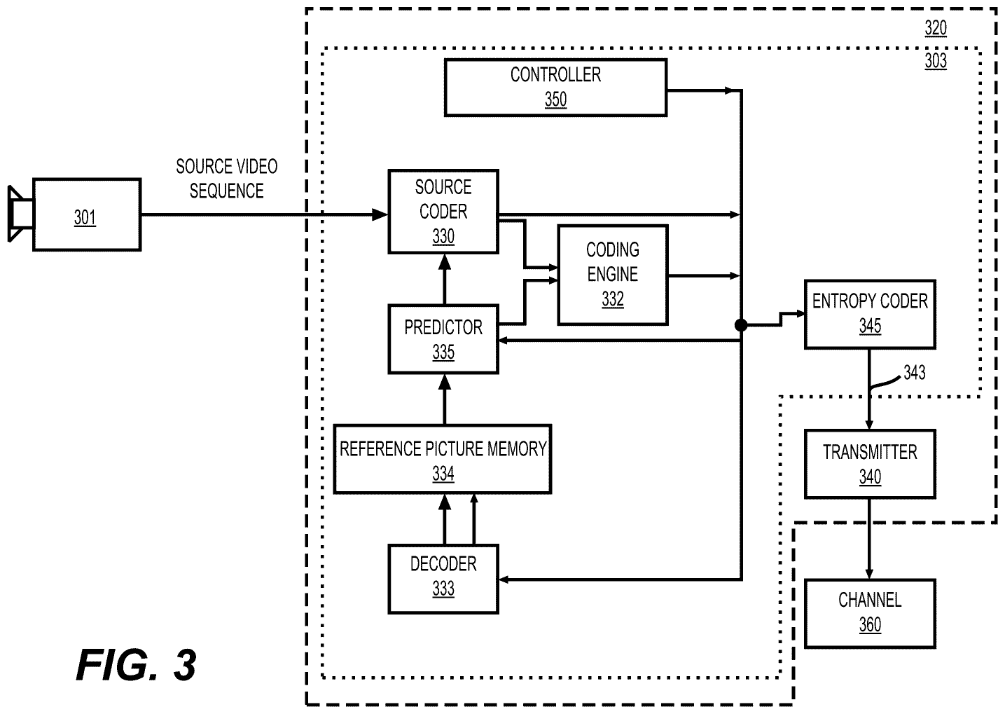

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

According to some aspects of the disclosure, video coding can be used in machine scenarios.

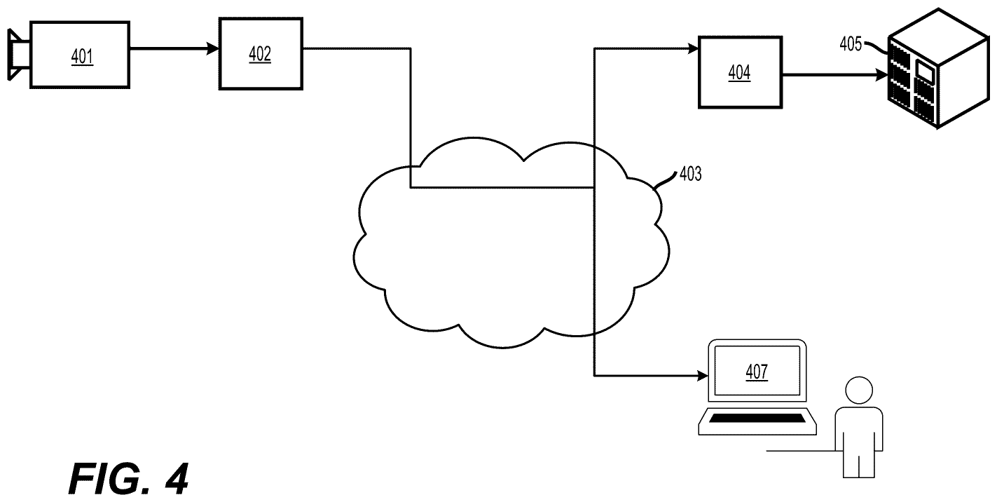

FIG. 4 shows a block diagram of a video processing system (400) in a hybrid machine-human consumption scenario in some examples. In the FIG. 4 example, the video processing system (400) includes a plurality of video sources for machine consumption. For example, the video processing system (400) includes a camera (401) coupled to an encoder device (402).

In some examples, an encoder can be optimized for hybrid machine-human consumption. For example, the encoder device (402) is optimized for encoding bitstreams for machine consumption and human consumption. For example, the encoder device (402) is coupled, via a network (403), to a first decoder device (404) and a second decoder device (407). The first decoder device (404) is coupled to a machine (405) that consumes the decoded video (e.g., perform further analysis, detection, and the like on the video). The second decoder device (407) is configured to provide decoded video for human consumption (e.g., to be viewed by human).

Thus, an encoded bitstream can be provided from the encoder device (402) to the first decoder device (404) and the second decoder device (407) via the network (403), and the encoded bitstream can be respectively decoded by the first decoder device (404) and the second decoder device (407). For example, first decoded video data by the first decoder device (404) can be further processed by the machine (405), and second decoded video data by the second decoder device (407) can be displayed for viewing by human.

Some aspects of the disclosure provide multi-layer coding techniques for hybrid machine (e.g., object tracking and detection) and human consumption. In some examples, the encoder device (402) is configured to encode video into coded video bitstreams according to the multi-layer coding techniques. The first decoder device (404) is configured to decode coded video bitstreams (e.g., coded using multi-layer coding techniques) according to the multi-layer coding techniques for machine tasks. The second decoder device (407) are configured to decode the coded video bitstreams (e.g., coded using multi-layer coding techniques) according to the multi-layer coding techniques for human consumption.

According to some aspects of the disclosure, to serve for different application use cases, e.g., scalable coding, multi-view coding and texture-depth coding, multi-layer coding mechanisms can be used. In a multi-layer video coding approach, one layer can represent any information of a view related to a particular camera perspective, e.g., texture, depth, or other metadata information, and dependency layers can be presented other than a base layer. A picture can be reconstructed using multiple layers, e.g., a base layer plus an enhancement layer, and one layer can use reconstruction of another layer as reference, i.e., inter-layer prediction.

In some examples, a scalable representation of video signals includes a base layer and multiple enhancement layers. The base layer provides a basic level of quality and can be decoded independently of the enhancement layers. On the other hand, the enhancement layers serve to refine the base layer quality and alone may be not useful. Therefore, the base layer represents the most critical part of the scalable representation, which makes the performance of streaming applications that employ layered representations sensitive to losses of base layer packets.

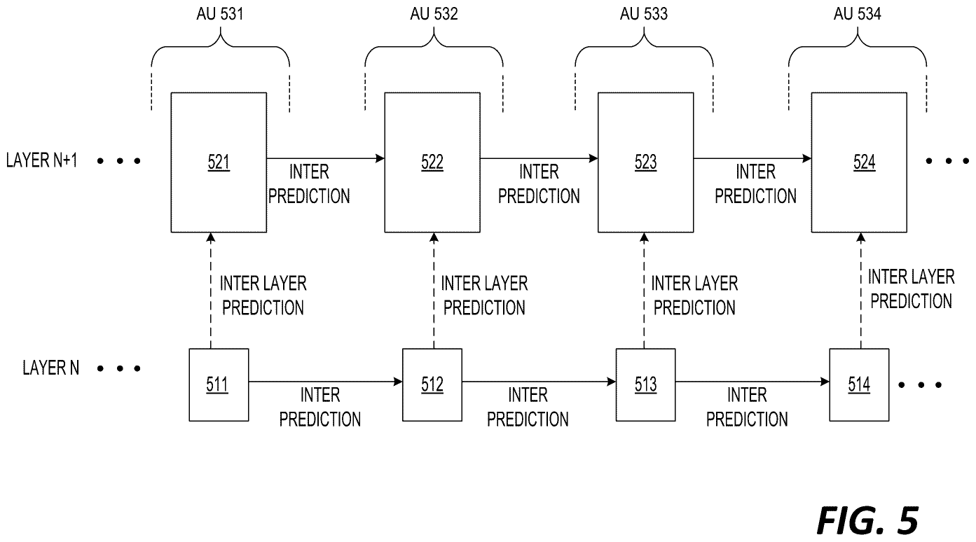

FIG. 5 shows a diagram of multi-layer coding in some examples. The multi-layer coding can include inter prediction and inter layer prediction.

FIG. 5 shows pictures (511), (512), (513), and (514) in a first layer (e.g., layer N) and pictures (521), (522), (523), and (524) in a second layer (e.g., layer N+1). In some examples, a layer, such as the first layer or the second layer, is a group of pictures that are all associated with a similar value of a characteristic, such as a similar size, quality, resolution, signal to noise ratio, capability, etc. In an example, the first layer is associated with a smaller image size than the second layer. Accordingly, the pictures (511), (512), (513), and (514) in the first layer have a smaller picture size than the pictures (521), (522), (523), and (524) in the second layer in the FIG. 5 example. It is noted that, the different layers can be other different characteristics. While only two layers are shown in FIG. 5, any number of layers can be used in multi-layer coding. In some examples, layer IDs can be used to identify the different layers.

In some examples, pictures in different layers are configured to be alternative. For example, the pictures (511)-(514) in the first layer and corresponding the pictures (521)-(524) can share the same temporal identifiers (IDs) and can be included in the same access units (AUs). In an example, an AU is a set of one or more coded pictures associated with the same display time for output from a decoded picture buffer (DPB). For example, a decoder can decode and display the picture (515) at a current display time when a smaller picture is desired or the decoder can decode and display picture (525) at the current display time when a larger picture is desired.

In some examples, pictures can be coded by reference to other pictures in the same layer. Coding a picture in reference to another picture in the same layer results in inter prediction, which is compatible unidirectional inter-prediction and/or bidirectional inter-prediction. Inter prediction can also be referred to as intra-layer prediction in a multi-layer coding context.

In some examples, pictures can also be coded by reference to other pictures in different layers. Coding a picture in reference to another picture in a different layer is referred to as inter-layer prediction. Inter-layer prediction is a mechanism of coding samples of a current picture by reference to indicated samples in a reference picture where the current picture and the reference picture are in different layers and hence have different layer IDs. For example, a picture in the first layer can be used as a reference picture to code a corresponding picture at the second layer. As a specific example, the picture (521) can be coded by reference to the picture (511) according to inter-layer prediction. In such a case, the picture (511) is used as an inter-layer reference picture. In some examples, inter-layer prediction is constrained such that a current picture, such as picture (521), can only use inter-layer reference picture(s) that are included in the same AU and that are at a lower layer, such as the picture (511). It is noted that, in some examples, inter-layer prediction can use inter-layer reference pictures that are included in different AU. When multiple layers (e.g., more than two) are available, inter-layer prediction can encode/decode a current picture based on multiple inter-layer reference picture(s) at lower levels than the current picture.

In some examples, each AU can contain several pictures. For example, one AU (531) can include the pictures (511) and (521). Another AU (532) can include the pictures (512) and (522). In an example, each AU is a set of one or more coded pictures associated with the same display time (e.g., the same temporal ID) for output from a decoded picture buffer (DPB) (e.g., for display to a user).

In an example, the AU (531) includes an intra random access point (IRAP) picture (e.g., picture 511) in the first layer and a non-IRAP picture (e.g., picture 521) in the second layer. That is, the same AU can include both IRAP and non-IRAP pictures in different layers.

Video compression can be used for not only human but also machine consumptions. In some examples, video compression for machine consumption can be based on traditional video codecs as the core codec. However, traditional video codecs are primarily standardized for video application served for human vision, and additional coding tools or pre-/post-processing methods can be applied on top of a traditional video codec to achieve a higher coding efficiency for machine consumptions, measured by bitrate and machine task scores, e.g., object detection accuracy rates.

The present disclosure provides methods of multi-layer coding for hybrid machine-human consumption. In some examples, encoder can generate a coded video bitstream for a video using a multi-layer coding. The coded video bitstream includes first coded information corresponding to first coded pictures of a first layer using a multi-layer coding on a video, the first layer serves for a machine task. The coded information also includes second coded information corresponding to second coded pictures of a second layer using the multi-layer coding on the video, the second layer serves for a human consumption. A decoder can receive the coded video bitstream, determine a consumption type from at least the machine task and the human consumption, and reconstruct, based on the consumption type, at least a reconstructed picture according to at least one of the first coded information and/or the second coded information.

The methods can be used separately or combined in any order. Further, each of the techniques (or embodiments), methods, encoders, and decoders can be implemented by processing circuitry (e.g., one or more processors or one or more integrated circuits). In one example, the one or more processors execute a program that is stored in a non-transitory computer-readable medium.

In the present disclosure, the bitstream can be produced by the techniques of the multi-layer coding, and can be used for generating reconstructed image/video for both machine consumptions and human consumptions.

According to some aspects of the disclosure, the multi-layer coding can be used to generate a coded video bitstream for hybrid machine-human consumption. In some aspects, a video bitstream is decoded using multiple layers, such as at least a first layer that is used for reconstructing pictures that serve for machine tasks, and at least a second layer (and/or together with the first layer used for reconstructing pictures that serve for machine tasks) is used for reconstructing pictures that serve for human consumptions.

In some aspects, the first layer, which is used for reconstructing pictures that serve for machine tasks, can be coded using coding tools that are applied for machine tasks. For example, a subset of tools from a related video codec (e.g., a related video codec that is standardized for video application served for human vision) is applied for the first layer.

In some examples, certain coding tools are tools for improving human perception and visual experience of human being, and can be excluded for applying on the first layer for coding simplicity. The tools to exclude can include intra subblock prediction (ISP), matrix-based intra prediction (MIP), decoder side derived intra mode (e.g., decoder-side intra mode derivation known as DIMD), optical flow-based motion refinement (e.g., bidirectional optical flow (BDOF)), merge with motion vector difference (MMVD), subblock transform (SBT), affine based techniques, bi-prediction with CU level weights (BCW), multiple transform set (MTS), non-separable primary transform (NSPT), and the like.

In some examples, the first layer, which is used for reconstructing pictures that serve for machine tasks, can be coded with contents that are labeled as region of interests (ROI). In an example, a first coded picture of the first layer corresponds to a portion of a picture for coding. The portion is labeled as ROI. In an example, the second layer includes a second coded picture corresponding to the picture for coding.

In some examples, the first layer, which is used for reconstructing pictures that serve for machine tasks, can be coded with truncated bit depth. In an example, the first layer includes a first coded picture with truncated bit depth, and the second layer includes a second coded picture with a different bit depth (e.g., non truncated bit depth) from the truncated bit depth, and the first coded picture and the second coded picture correspond to a same picture for coding.

In some examples, the first layer, which is used for reconstructing pictures that serve for machine tasks, can be coded with residual samples further scaled. In an example, the first layer includes a first coded picture with residual samples further scaled, and the second layer is a second coded picture with residual samples (not further scaled), and the first coded picture and the second coded picture correspond to a same picture for coding.

In some examples, the first layer, which is used for reconstructing pictures that serve for machine tasks, can be coded with different spatial and/or temporal sampling ratio. For example, the first layer includes pictures that are spatially down-sampled and/or temporally down-sampled.

In some examples, the first layer, which is used for reconstructing pictures that serve for machine tasks, can be encoded/decoded using machine learning based video coding schemes, including but not limited to end-to-end intra picture coding, neural network based coding tools (e.g., loop filtering, super resolution, frame interpolation etc.).

In some aspects, the reconstruction of a picture/video for machine (and/or human) consumption can be derived using multiple layers.

In some examples, one layer includes textures regions that belong to ROI, and one layer includes texture regions that do not belong to ROI. For example, the first layer includes texture regions that belong to ROI, and the second layer includes texture regions that do not belong to ROI.

In some examples, the reconstruction is performed by selecting samples from one or a subset of layers, instead of adding the reconstruction samples of multiple layers. In an example, to generate a reconstructed picture, one of more samples can be selected from a coded picture of the first layer, and one or more samples can be selected from a coded picture of the second layer. In an example, for reconstruction of each sample, the selection of the reconstruction samples from different layers depends on the region specified by the ROI. For example, when a sample is in the region of interest, the sample is selected from the first layer, and when the sample is out of the region of interest, the sample is selected from the second layer.

In some examples, for partial samples, the reconstruction is performed by selecting samples from one or a subset of layers, the reconstruction is performed by adding the reconstruction samples of multiple layers. In an example, for a sample to reconstruct, a first partial sample is decoded from a first coded picture of the first layer, and a second partial sample is decoded from a second coded picture of the second layer. The first partial sample and the second partial sample can be combined (e.g., added) to form the reconstructed sample.

In some aspects, the inter-layer prediction can be performed using a layer, which is used for machine task, as a reference. The layer used for machine task is also referred to as a base layer in an example.

In some examples, when deriving the prediction samples of a layer, the reference block can come from another layer coded using ROI. For example, pictures in the first layer are coded using ROI for machine task, and to derive prediction samples of coded pictures in a second layer, reference blocks in the first layer can be used.

In an example, only reference samples that are located within ROI (of the first layer), are used for generating the prediction samples (of the second layer). In an example, samples in ROI of the first layer are coded with better coding quality, and using the reference samples in ROI can improve prediction quality.

In some examples, for samples that are located outside ROI in the first layer, the samples are excluded for being used as reference for generating the prediction samples (of the second layer). For example, for a current picture of bi-prediction, a first reference frame is from a different layer that is coded with ROI, and a second reference frame is from the same layer as the current picture. For reference sample locations of the first reference frame that are outside ROI, uni-prediction is applied using the second reference frame, and for reference sample locations of the first reference frame that are within ROI, bi-prediction can be applied using both the first reference frame and the second reference frame.

In some examples, when a reference block for generating prediction samples are partially/fully located outside ROI, only uni-prediction is applied.

In some aspects, when deriving the prediction samples of a layer, the motion vector predictor (MVP) can come from another layer coded using ROI.

In some examples, when a temporal motion vector prediction (TMVP) candidate is derived from the first layer coded using ROI, and the TMVP candidate is not located within ROI, then this TMVP candidate cannot be used as a motion vector predictor.

In some examples, when a temporal motion vector prediction (TMVP) candidate is derived from the first layer coded using ROI, and the TMVP candidate is not located within ROI, then the motion vector associated with a different location within ROI, such as a closest location in ROI, is used as the TMVP candidate.

In some examples, a subblock based temporal motion vector prediction (SbTMVP) candidate is derived from the first layer coded using ROI, the SbTMVP candidate corresponds to a block (also referred to as a subblock in an example) with motion vectors associated with samples in the block. In an example, when the samples of the block are within the ROI, the motion vectors associated with the samples can be used as the motion vector predictor.

In some examples, when a subblock is located outside ROI, the motion vector predictor associated with this subblock can be padded with the motion vector associated with other subblock, such as other subblock in the ROI.

In an aspect, when deriving the prediction samples of the second layer, the reference samples for deriving the prediction samples can come from the first layer that is coded with a different truncated bit depth. In some examples, the reference samples from the first layer can be processed by reverse bit depth truncation before being applied as the prediction samples for the second layer.

In an aspect, when deriving the prediction samples of the second layer, the reference samples for deriving the prediction samples can come from the first layer that is coded with scaled residual samples. In some examples, residual samples from the first layer can be processed by reverse scaling before being applied as the prediction samples for the second layer.

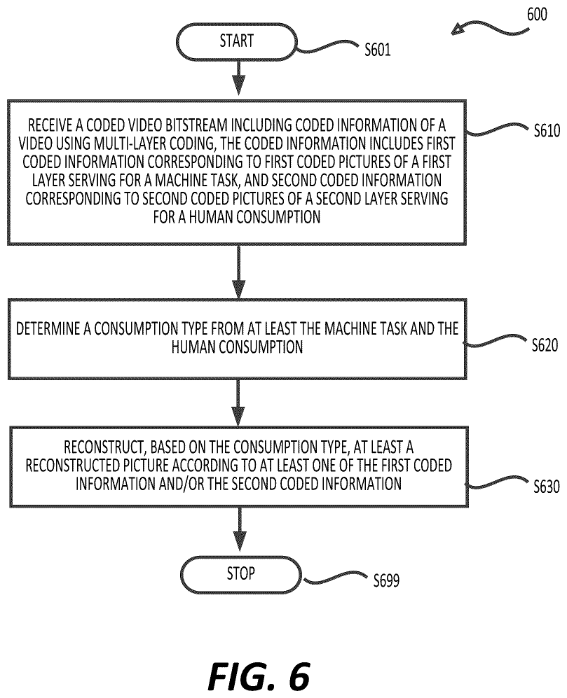

FIG. 6 shows a flow chart outlining a process (600) according to an aspect of the disclosure. The process (600) can be used in a video decoder. In various aspects, the process (600) is executed by processing circuitry, such as the processing circuitry that performs functions of the video decoder (110), the processing circuitry that performs functions of the video decoder (210), and the like. In some aspects, the process (600) is implemented in software instructions, thus when the processing circuitry executes the software instructions, the processing circuitry performs the process (600). The process starts at (S601) and proceeds to (S610).

At (S610), a coded video bitstream is received. The coded video bitstream includes coded information of a video using multi-layer coding. The coded information includes first coded information corresponding to first coded pictures of a first layer serving for a machine task, and second coded information corresponding to second coded pictures of a second layer serving for a human consumption.

At (S620), a consumption type is determined from at least the machine task and the human consumption.

At (S630), based on the consumption type, at least a reconstructed picture is reconstructed according to at least one of the first coded information and/or the second coded information.

In some examples, when the consumption type is the machine task, the reconstructed picture is reconstructed according to the first coded information. In some examples, when the consumption type is the human consumption, the reconstructed picture is reconstructed from the second coded information. In some examples, when the consumption type is the human consumption, the reconstructed picture is reconstructed according to the first coded information and the second coded information.

In some aspects, the first coded information is coded using a subset of coding tools of a video codec, the subset of coding tools being associated with the machine task. For example, the first coded information comprises at least one of coded information of only contents that are labeled as region of interest (ROI) in the video, coded information with a truncated bit depth, coded information of residual samples that are scaled by one or more scaling values, and/or coded information of a different spatial and/or temporal sampling ratio from an original ratio value of the video.

In some examples, the first coded information includes coded information of only contents that are labeled region of interest (ROI) in the video, and a portion corresponding to the ROI in the reconstructed picture is reconstructed based on the first coded information.

In some examples, the first coded information includes coded information with a truncated bit depth. The reconstructed picture is reconstructed from the first coded information according to the truncated bit depth.

In some examples, the first coded information includes coded information coded information of residual samples of a block that are scaled by one or more scaling values. In an example, scaled residual samples of the block are obtained from the first coded information (e.g., by applying an inverse transform on transform coefficients of the block decoded from the first coded information). Restored residual samples are generated from the scaled residual samples according to one or more scaling values. The block can be based on the restored residual samples.

In some examples, the reconstructed picture is reconstructed from the first coded information using a neural network that is pre-trained according to machine learning.

In some aspects, the reconstructed picture is reconstructed from the first coded information and the second coded information. In an example, a first block of the reconstructed picture is reconstructed from the first coded information when the first block belongs to a region of interest (ROI); and a second block of the reconstructed picture is reconstructed from the second coded information when the second block does not belong to the ROI.

In another example, whether a sample belongs to a region of interest (ROI) is determined. The sample is reconstructed from the first coded information when the sample belongs to the region of interest; and the sample is reconstructed from the second coded information when the sample is located out of the region of interest.

In another example, a first sub-sample value of a sample in the reconstructed picture is determined according to the first coded information, and a second sub-sample value of the sample in the reconstructed picture is determined according to the second coded information of the second layer. The sample is reconstructed according to an addition of the first sub-sample value and the second sub-sample value.

In some aspects, a first picture corresponding to a first coded picture in the first coded pictures of the first layer is reconstructed according to the first coded information. Also, using an inter-layer prediction, one or more samples of a second coded picture in the second layer are reconstructed based on at least a first sample in the first picture of the first layer.

In some examples, the first picture includes a portion that is labeled as a region of interest. To the reconstruct the one or more samples of the second coded picture, a block of the second coded picture is reconstructed according to a refence block that is within the portion labeled as the region of interest.

In an example, a reference block candidate for the one or more samples is determined to be located outside of the portion, and the reference block candidate is excluded from the inter-layer prediction.

In some aspects, a motion vector for the one or more samples of the second coded picture is determined based on a motion vector predictor located in the portion of the first picture.

In some examples, a temporal motion vector prediction (TMVP) candidate of the first picture for the motion vector predictor is determined to be located out of the portion labeled as the region of interest. The TMVP candidate is excluded from being the motion vector predictor.

In some examples, a temporal motion vector prediction (TMVP) candidate of the first picture for the motion vector predictor is determined to be located out of the portion labeled as the region of interest, and a substitute TMVP candidate in the portion labeled as the region of interest is determined to be the motion vector predictor for the one or more samples of the second coded picture.

In some examples, when a subblock based TMVP (SbTMVP) candidate is located within the portion labeled as the region of interest, a subblock based temporal motion vector prediction (SbTMVP) is performed to determine motion vectors for samples in a second subblock of the second coded picture based on the SbTMVP candidate in the first picture.

In some examples, a subblock based temporal motion vector prediction (SbTMVP) candidate in the first picture for predicting motion vectors of samples in a second subblock of the second coded picture is determined to include at least a sample located out of the portion labeled as the region of interest. At least the sample in the SbTMVP candidate can be padded with a motion vector of another sample that is located within the portion labeled as the region of interest. Then, the motion vectors of the samples in the second subblock of the second coded picture can be determined based on the SbTMVP candidate.

In some examples, the first coded information includes coded information with a different truncated bit depth from the second coded information. A reverse bit depth truncation can be performed on at least the first sample decoded from the first coded information to generate at least a restored first sample. Using the inter-layer prediction, the one or more samples of the second coded picture in the second layer are reconstructed based on at least the restored first sample in the first picture.

In some examples, the first coded information includes coded information of residual samples that are scaled by one or more scaling values. In an examples, scaled residual samples are obtained from the first coded information. A reverse scaling is applied on the scaled residual samples in the first picture of the first layer to generate restored residual samples. First samples of the first picture are reconstructed based on the restored residual samples. Using the inter-layer prediction, the one or more samples of the second coded picture in the second layer are reconstructed based on at least the first samples of the first picture.

Then, the process proceeds to (S699) and terminates.

The process (600) can be suitably adapted. Step(s) in the process (600) can be modified and/or omitted. Additional step(s) can be added. Any suitable order of implementation can be used.

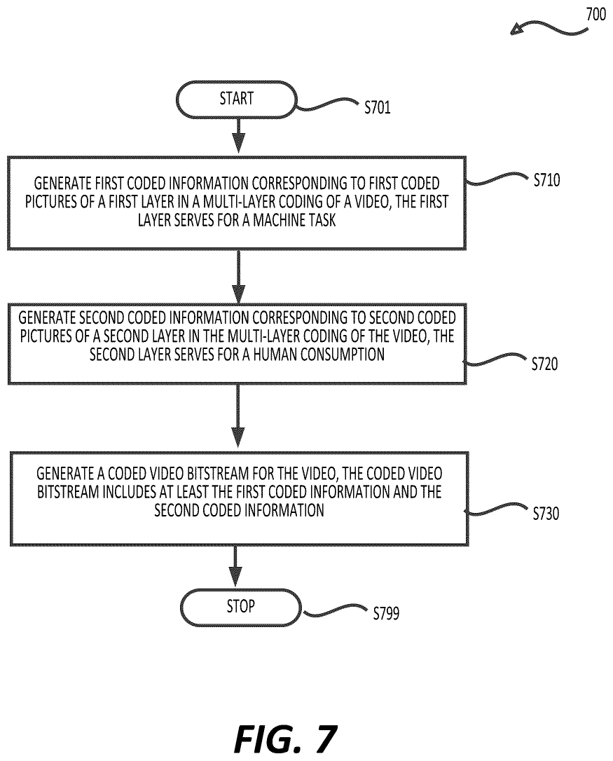

FIG. 7 shows a flow chart outlining a process (700) according to an aspect of the disclosure. The process (700) can be used in a video encoder. In various aspects, the process (700) is executed by processing circuitry, such as the processing circuitry that performs functions of the video encoder (103), the processing circuitry that performs functions of the video encoder (303), and the like. In some aspects, the process (700) is implemented in software instructions, thus when the processing circuitry executes the software instructions, the processing circuitry performs the process (700). The process starts at (S701) and proceeds to (S710).

At (S710), first coded information is generated. The first coded information corresponds to first coded pictures of a first layer in a multi-layer coding of a video, the first layer serves for a machine task.

At (S720), second coded information is generated. The second coded information corresponds to second coded pictures of a second layer in the multi-layer coding of the video, the second layer serves for a human consumption.

At (S730), a coded video bitstream for the video is generated, the coded video bitstream includes at least the first coded information and the second coded information.

In some examples, the second coded information is generated independent of the first coded information. In some examples, the second coded information is generated based on the first coded information.

In some aspects, the first coded information is encoded using a subset of coding tools of a video codec, the subset of coding tools being associated with the machine task. For example, the first coded information includes at least one of: coded information of only contents that are labeled as region of interest (ROI) in the video, coded information with a truncated bit depth, coded information of residual samples that are scaled by one or more scaling values, and/or coded information of a different spatial and/or temporal sampling ratio from an original ratio value of the video.

In some aspects, the first coded information is encoded using a neural network that is pre-trained according to machine learning.

In some aspects, a picture of the video is encoded into the first coded information and the second coded information using the multi-layer coding.

In some examples, a first block of the picture is encoded into the first coded information when the first block belongs to a region of interest (ROI); and a second block of the picture is encoded into the second coded information when the second block does not belong to the ROI.

In some examples, whether a sample belongs to a region of interest (ROI) is determined. The sample is encoded into the first coded information when the sample belongs to the region of interest, and the sample is encoded into the second coded information when the sample is located out of the region of interest.

In some examples, a sample value of a sample is split into a first sub-sample value and a second sub-sample value. The first sub-sample value of the sample is encoded into the first coded information. The second sub-sample value of the sample is encoded into the second coded information.

In some examples, a first picture corresponding to a first coded picture in the first coded pictures of the first layer is reconstructed according to the first coded information. Using an inter-layer prediction, one or more samples of a second coded picture in the second layer is encoded based on at least a first sample in the first picture of the first layer.

In some examples, the first picture includes a portion that is labeled as a region of interest. A block of the second coded picture is encoded according to a refence block that is within the portion labeled as the region of interest.

In some examples, when a reference block candidate for the one or more samples is determined to be located outside of the portion labeled as the ROI, the reference block candidate is excluded from the inter-layer prediction.

In some examples, the one or more samples of the second coded picture are encoded based on a motion vector predictor located in the portion of the first picture, the motion vector predictor is used to predict a motion vector for encoding the one or more samples.

In some examples, a temporal motion vector prediction (TMVP) candidate of the first picture for the motion vector predictor is determined to be located out of the portion labeled as the region of interest, and the TMVP candidate is excluded from being the motion vector predictor.

In some examples, a temporal motion vector prediction (TMVP) candidate of the first picture for the motion vector predictor is determined to be located out of the portion labeled as the region of interest, and a substitute TMVP candidate in the portion labeled as the region of interest is determined to be the motion vector predictor for the one or more samples of the second coded picture, and the one or more samples of the second coded picture are encoded based on the substitute TMVP candidate.

In some examples, a subblock based temporal motion vector prediction (SbTMVP) candidate in the first picture is determined to be located within the portion labeled as the region of interest, and a subblock in the second coded picture is encoded using a subblock based temporal motion vector prediction (SbTMVP) that determines motion vectors for samples in the second subblock of the second coded picture based on the SbTMVP candidate.

In some examples, a subblock based temporal motion vector prediction (SbTMVP) candidate in the first picture for predicting motion vectors of samples in a second subblock of the second coded picture includes at least a first sample located out of the portion labeled as the region of interest. At least the first sample in the SbTMVP candidate is padded with a motion vector of a second sample that is located within the portion labeled as the region of interest. The second subblock of the second coded picture is encoded based on the SbTMVP candidate.

In some examples, the first coded information is generated with a truncated bit depth. First samples in the first picture are reconstructed according to the first coded information. A reverse bit depth truncation is performed on the first samples to generate restored first samples. Using the inter-layer prediction, one or more samples of the second coded picture in the second layer are encoded based on at least the restored first samples in the first picture.

In some examples, the first coded information includes coded information of residual samples that are scaled by one or more scaling values. The first coded information is generated with residual samples being scaled by one or more scaling factors. Scaled residual samples can be extracted from the first coded information. A reverse scaling can be applied on at least the scaled residual samples to generate restored residual samples. Using the inter-layer prediction, the one or more samples of the second coded picture in the second layer are encoded based on the restored residual samples of the first picture.

Then, the process proceeds to (S799) and terminates.

The process (700) can be suitably adapted. Step(s) in the process (700) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of a video using multi-layer coding, the coded information includes first coded information corresponding to first coded pictures of a first layer serving for a machine task, and second coded information corresponding to second coded pictures of a second layer serving for a human consumption. The format rule specifies that: a consumption type is determined from at least the machine task and the human consumption; and based on the consumption type, at least a reconstructed picture is reconstructed according to at least one of the first coded information and/or the second coded information.

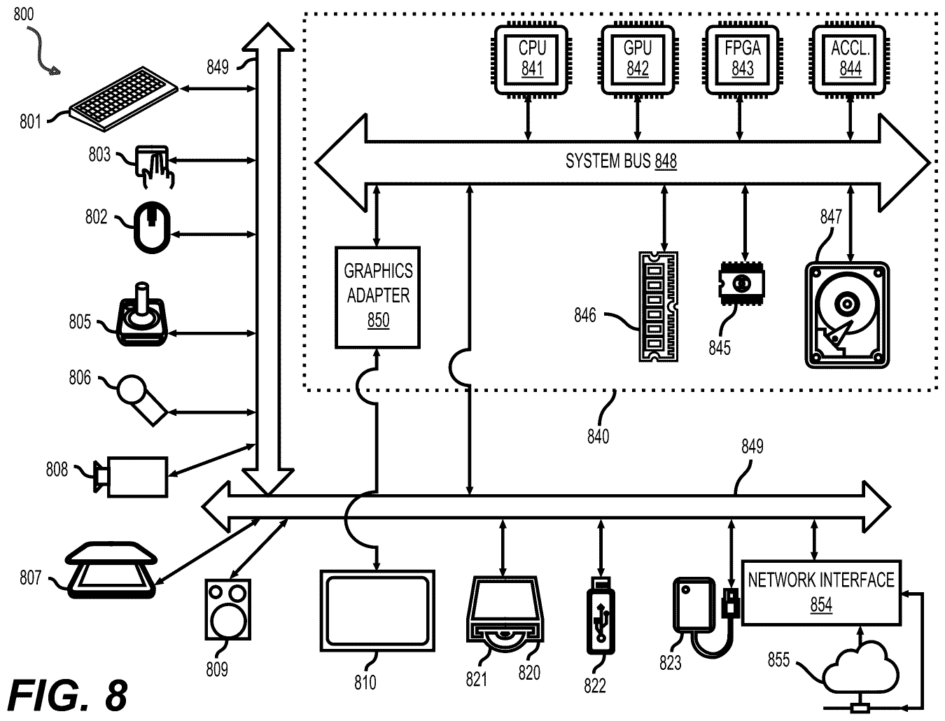

The techniques described above, can be implemented as computer software using computer-readable instructions and physically stored in one or more computer-readable media. For example, FIG. 8 shows a computer system (800) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 8 for computer system (800) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (800).

Computer system (800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (801), mouse (802), trackpad (803), touch screen (810), data-glove (not shown), joystick (805), microphone (806), scanner (807), camera (808).

Computer system (800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (810), data-glove (not shown), or joystick (805), but there can also be tactile feedback devices that do not serve as input devices), audio output devices (such as: speakers (809), headphones (not depicted)), visual output devices (such as screens (810) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (800) can also include human accessible storage devices and their associated media such as optical media including CD/DVD ROM/RW (820) with CD/DVD or the like media (821), thumb-drive (822), removable hard drive or solid state drive (823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (800) can also include an interface (854) to one or more communication networks (855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (849) (such as, for example USB ports of the computer system (800)); others are commonly integrated into the core of the computer system (800) by attachment to a system bus as described below (for example Ethernet interface into a PC computer system or cellular network interface into a smartphone computer system). Using any of these networks, computer system (800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (840) of the computer system (800).

The core (840) can include one or more Central Processing Units (CPU) (841), Graphics Processing Units (GPU) (842), specialized programmable processing units in the form of Field Programmable Gate Areas (FPGA) (843), hardware accelerators for certain tasks (844), graphics adapters (850), and so forth. These devices, along with Read-only memory (ROM) (845), Random-access memory (846), internal mass storage such as internal non-user accessible hard drives, SSDs, and the like (847), may be connected through a system bus (848). In some computer systems, the system bus (848) can be accessible in the form of one or more physical plugs to enable extensions by additional CPUs, GPU, and the like. The peripheral devices can be attached either directly to the core's system bus (848), or through a peripheral bus (849). In an example, the screen (810) can be connected to the graphics adapter (850). Architectures for a peripheral bus include PCI, USB, and the like.

CPUs (841), GPUs (842), FPGAs (843), and accelerators (844) can execute certain instructions that, in combination, can make up the aforementioned computer code. That computer code can be stored in ROM (845) or RAM (846). Transitional data can also be stored in RAM (846), whereas permanent data can be stored for example, in the internal mass storage (847). Fast storage and retrieve to any of the memory devices can be enabled through the use of cache memory, that can be closely associated with one or more CPU (841), GPU (842), mass storage (847), ROM (845), RAM (846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (800), and specifically the core (840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (840) that are of non-transitory nature, such as core-internal mass storage (847) or ROM (845). The software implementing various aspects of the present disclosure can be stored in such devices and executed by core (840). A computer-readable medium can include one or more memory devices or chips, according to particular needs. The software can cause the core (840) and specifically the processors therein (including CPU, GPU, FPGA, and the like) to execute particular processes or particular parts of particular processes described herein, including defining data structures stored in RAM (846) and modifying such data structures according to the processes defined by the software. In addition or as an alternative, the computer system can provide functionality as a result of logic hardwired or otherwise embodied in a circuit (for example: accelerator (844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1). A method of video decoding, including: receiving a coded video bitstream including coded information of a video using multi-layer coding, the coded information including first coded information corresponding to first coded pictures of a first layer serving for a machine task, and second coded information corresponding to second coded pictures of a second layer serving for a human consumption; determining a consumption type from at least the machine task and the human consumption; and reconstructing, based on the consumption type, at least a reconstructed picture according to at least one of the first coded information and/or the second coded information.

(2). The method of feature (1), in which when the consumption type is machine task, the reconstructing includes reconstructing he reconstructed picture according to the first coded information; and when the consumption type is the human consumption, the reconstructing includes at least one of: reconstructing the reconstructed picture according to the second coded information; and/or reconstructing the reconstructed picture according to the first coded information and the second coded information.

(3). The method of any of features (1) to (2), in which the first coded information is coded using a subset of coding tools of a video codec, the subset of coding tools being associated with the machine task.

(4). The method of any of features (1) to (3), in which the first coded information includes at least one of: coded information of only contents that are labeled as region of interest (ROI) in the video; coded information with a truncated bit depth; coded information of residual samples that are scaled by one or more scaling values; and/or coded information of a different spatial and/or temporal sampling ratio from an original ratio value of the video.

(5). The method of any of features (1) to (4), in which the first coded information includes coded information of only contents that are labeled region of interest (ROI) in the video, and the method includes: reconstructing a portion corresponding to the ROI in the reconstructed picture based on the first coded information.

(6). The method of any of features (1) to (5), in which the first coded information includes coded information with a truncated bit depth, and the method includes: reconstructing the reconstructed picture from the first coded information according to the truncated bit depth.

(7). The method of any of features (1) to (6), in which the first coded information includes coded information coded information of residual samples of a block that are scaled by one or more scaling values, and the method includes: obtaining scaled residual samples of the block from the first coded information; generating restored residual samples from the scaled residual samples according to one or more scaling values; and reconstructing the block based on the restored residual samples.

(8). The method of any of features (1) to (7), in which the reconstructing includes: reconstructing the reconstructed picture from the first coded information using a neural network that is pre-trained according to machine learning.

(9). The method of any of features (1) to (8), in which the reconstructing includes: reconstructing the reconstructed picture from the first coded information and the second coded information.

(10). The method of any of features (1) to (9), in which the reconstructing includes: generating a first block of the reconstructed picture from the first coded information when the first block belongs to a region of interest (ROI); and generating a second block of the reconstructed picture from the second coded information when the second block does not belong to the ROI.

(11). The method of any of features (1) to (10), in which the reconstructing includes: determining whether a sample belongs to a region of interest (ROI); reconstructing the sample from the first coded information when the sample belongs to the region of interest; and reconstructing the sample from the second coded information when the sample is located out of the region of interest.

(12). The method of any of features (1) to (11), in which the reconstructing includes: determining a first sub-sample value of a sample in the reconstructed picture according to the first coded information; determining a second sub-sample value of the sample in the reconstructed picture according to the second coded information of the second layer; and reconstructing the sample according to an addition of the first sub-sample value and the second sub-sample value.

(13). The method of any of features (1) to (12), in which the reconstructing includes: reconstructing a first picture corresponding to a first coded picture in the first coded pictures of the first layer according to the first coded information; and reconstructing, using an inter-layer prediction, one or more samples of a second coded picture in the second layer based on at least a first sample in the first picture of the first layer.

(14). The method of any of features (1) to (13), in which the first picture includes a portion that is labeled as a region of interest, and the reconstructing the one or more samples of the second coded picture includes: reconstructing a block of the second coded picture according to a refence block that is within the portion labeled as the region of interest.

(15). The method of any of features (1) to (14), in which the first picture includes a portion that is labeled as region of interest, and the method includes: determining that a reference block candidate for the one or more samples is in the first picture and is located outside of the portion; and excluding the reference block candidate for the inter-layer prediction.

(16). The method of any of features (1) to (15), in which the first picture includes a portion that is labeled as region of interest, and the method includes: determining a motion vector for the one or more samples of the second coded picture based on a motion vector predictor located in the portion of the first picture.

(17). The method of any of features (1) to (16), further including: determining that a temporal motion vector prediction (TMVP) candidate of the first picture for the motion vector predictor is located out of the portion labeled as the region of interest; and excluding the TMVP candidate to be the motion vector predictor.

(18). The method of any of features (1) to (17), further including: determining that a temporal motion vector prediction (TMVP) candidate of the first picture for the motion vector predictor is located out of the portion labeled as the region of interest; and determining a substitute TMVP candidate in the portion labeled as the region of interest to be the motion vector predictor for the one or more samples of the second coded picture.

(19). The method of any of features (1) to (18), further including: performing a subblock based temporal motion vector prediction (SbTMVP) to determine motion vectors for samples in a second subblock of the second coded picture based on a SbTMVP candidate in the first picture when the SbTMVP candidate is located within the portion labeled as the region of interest.

(20). The method of any of features (1) to (19), further including: determining that a subblock based temporal motion vector prediction (SbTMVP) candidate in the first picture for predicting motion vectors of samples in a second subblock of the second coded picture includes at least a first sample located out of the portion labeled as the region of interest; padding at least the first sample in the SbTMVP candidate with a motion vector of a second sample that is located within the portion labeled as the region of interest; and determining the motion vectors of the samples in the second subblock of the second coded picture based on the SbTMVP candidate.

(21). The method of any of features (1) to (20), in which the first coded information includes coded information with a different truncated bit depth from the second coded information, and method includes: performing a reverse bit depth truncation on at least the first sample in the first picture of the first layer to generate at least a restored first sample; and reconstructing, using the inter-layer prediction, the one or more samples of the second coded picture in the second layer based on at least the restored first sample in the first picture.

(22). The method of any of features (1) to (21), in which the first coded information includes coded information of residual samples that are scaled by one or more scaling values, and method includes: obtaining scaled residual samples from the first coded information; performing a reverse scaling on the scaled residual samples in the first picture of the first layer to generate restored residual samples; reconstructing first samples of the first picture based on the restored residual samples; and reconstructing, using the inter-layer prediction, the one or more samples of the second coded picture in the second layer based on at least the first samples of the first picture.

(23). A method of video encoding, including: generating first coded information corresponding to first coded pictures of a first layer using a multi-layer coding on a video, the first layer serving for a machine task; generating second coded information corresponding to second coded pictures of a second layer using the multi-layer coding on the video, the second layer serving for a human consumption; and generating a coded video bitstream for the video, the coded video bitstream including at least the first coded information and the second coded information.

(24). The method of feature (23), in which the second coded information is generated independent of the first coded information or is generated based on the first coded information.

(25). The method of any of features (23) to (24), in which the first coded information is encoded using a subset of coding tools of a video codec, the subset of coding tools being associated with the machine task.

(26). The method of any of features (23) to (25), in which the first coded information includes at least one of: coded information of only contents that are labeled as region of interest (ROI) in the video; coded information with a truncated bit depth; coded information of residual samples that are scaled by one or more scaling values; and/or coded information of a different spatial and/or temporal sampling ratio from an original ratio value of the video.

(27). The method of any of features (23) to (26), further including: generating the first coded information using a neural network that is pre-trained according to machine learning.

(28). The method of any of features (23) to (27), further including: encoding a picture of the video into the first coded information and the second coded information using the multi-layer coding.

(29). The method of any of features (23) to (28), further including: encoding a first block of the picture into the first coded information when the first block belongs to a region of interest (ROI); and encoding a second block of the picture into the second coded information when the second block does not belong to the ROI.

(30). The method of any of features (23) to (29), further including: determining whether a sample belongs to a region of interest (ROI); encoding the sample into the first coded information when the sample belongs to the region of interest; and encoding the sample into the second coded information when the sample is located out of the region of interest.

(31). The method of any of features (23) to (30), further including: splitting a sample value of a sample into a first sub-sample value and a second sub-sample value; encoding the first sub-sample value of the sample into the first coded information; and encoding the second sub-sample value of the sample into the second coded information.

(32). The method of any of features (23) to (31), further including: reconstructing a first picture corresponding to a first coded picture in the first coded pictures of the first layer according to the first coded information; and encoding, using an inter-layer prediction, one or more samples of a second coded picture in the second layer based on at least a first sample in the first picture of the first layer.

(33). The method of any of features (23) to (32), in which the first picture includes a portion that is labeled as a region of interest, and the method includes: encoding a block of the second coded picture according to a refence block that is within the portion labeled as the region of interest.

(34). The method of any of features (23) to (33), in which the first picture includes a portion that is labeled as region of interest, and the method includes: determining that a reference block candidate for the one or more samples is in the first picture and is located outside of the portion; and excluding the reference block candidate for the inter-layer prediction.

(35). The method of any of features (23) to (34), in which the first picture includes a portion that is labeled as region of interest, and the method includes: encoding the one or more samples of the second coded picture based on a motion vector predictor located in the portion of the first picture, the motion vector predictor being used to predict a motion vector for the one or more samples.

(36). The method of any of features (23) to (35), further including: determining that a temporal motion vector prediction (TMVP) candidate of the first picture for the motion vector predictor is located out of the portion labeled as the region of interest; and excluding the TMVP candidate from being the motion vector predictor.

(37). The method of any of features (23) to (36), further including: determining that a temporal motion vector prediction (TMVP) candidate of the first picture for the motion vector predictor is located out of the portion labeled as the region of interest; determining a substitute TMVP candidate in the portion labeled as the region of interest to be the motion vector predictor for the one or more samples of the second coded picture; and encoding the one or more samples of the second coded picture based on the substitute TMVP candidate.

(38). The method of any of features (23) to (37), further including: determining that a subblock based temporal motion vector prediction (SbTMVP) candidate in the first picture is located within the portion labeled as the region of interest; and encoding a second subblock in the second coded picture using a subblock based temporal motion vector prediction (SbTMVP) that determines motion vectors for samples in the second subblock of the second coded picture based on the SbTMVP candidate.

(39). The method of any of features (23) to (38), further including: determining that a subblock based temporal motion vector prediction (SbTMVP) candidate in the first picture for predicting motion vectors of samples in a second subblock of the second coded picture includes at least a first sample located out of the portion labeled as the region of interest; padding at least the first sample in the SbTMVP candidate with a motion vector of a second sample that is located within the portion labeled as the region of interest; and encoding the second subblock of the second coded picture based on the SbTMVP candidate.

(40). The method of any of features (23) to (39), further includes: generating the first coded information with a truncated bit depth; reconstructing first samples in the first picture according to the first coded information; performing a reverse bit depth truncation on the first samples to generate restored first samples; and encoding, using the inter-layer prediction, one or more samples of the second coded picture in the second layer based on at least the restored first samples in the first picture.

(41). The method of any of features (23) to (40), in which the first coded information includes coded information of residual samples that are scaled by one or more scaling values, and method includes: generating the first coded information with residual samples being scaled by one or more scaling values; extracting scaled residual samples from the first coded information; performing a reverse scaling on the scaled residual samples to generate restored residual samples; and encoding, using the inter-layer prediction, the one or more samples of the second coded picture in the second layer based on the restored residual samples of the first picture.

(42). A method of video processing, the method including: processing a bitstream of video data according to a format rule, in which: the bitstream includes coded information of a video using multi-layer coding, the coded information includes first coded information corresponding to first coded pictures of a first layer serving for a machine task, and second coded information corresponding to second coded pictures of a second layer serving for a human consumption; and the format rule specifies that: a consumption type is determined from at least the machine task and the human consumption; and based on the consumption type, at least a reconstructed picture is reconstructed according to at least one of the first coded information and/or the second coded information.

(43). An apparatus for video decoding, including processing circuitry that is configured to perform the method of any of features (1) to (22).

(44). An apparatus for video encoding, including processing circuitry that is configured to perform the method of any of features (23) to (41).

(45). A non-transitory computer-readable storage medium storing instructions which when executed by at least one processor cause the at least one processor to perform the method of any of features (1) to (42).

What is claimed is:

1. A method of video decoding, comprising:
receiving a coded video bitstream comprising coded information of a video using multi-layer coding, the coded information comprising first coded information corresponding to first coded pictures of a first layer serving for a machine task, and second coded information corresponding to second coded pictures of a second layer serving for a human consumption;
determining a consumption type from at least the machine task and the human consumption; and
reconstructing, based on the consumption type, at least a reconstructed picture according to at least one of the first coded information and/or the second coded information.

2. The method of claim 1, wherein:
when the consumption type is machine task, the reconstructing comprises:
reconstructing he reconstructed picture according to the first coded information; and
when the consumption type is the human consumption, the reconstructing comprises at least one of:
reconstructing the reconstructed picture according to the second coded information; and/or
reconstructing the reconstructed picture according to the first coded information and the second coded information.

3. The method of claim 1, wherein the first coded information is coded using a subset of coding tools of a video codec, the subset of coding tools being associated with the machine task.

4. The method of claim 3, wherein the first coded information comprises at least one of:
coded information of only contents that are labeled as region of interest (ROI) in the video;
coded information with a truncated bit depth;
coded information of residual samples that are scaled by one or more scaling values; and/or
coded information of a different spatial and/or temporal sampling ratio from an original ratio value of the video.

5. The method of claim 3, wherein the reconstructing comprises:
reconstructing the reconstructed picture from the first coded information using a neural network that is pre-trained according to machine learning.

6. The method of claim 1, wherein the reconstructing comprises:
reconstructing the reconstructed picture from the first coded information and the second coded information.

7. The method of claim 6, wherein the reconstructing comprises:
generating a first block of the reconstructed picture from the first coded information when the first block belongs to a region of interest (ROI); and
generating a second block of the reconstructed picture from the second coded information when the second block does not belong to the ROI.

8. The method of claim 6, wherein the reconstructing comprises:
determining whether a sample belongs to a region of interest (ROI);
reconstructing the sample from the first coded information when the sample belongs to the region of interest; and
reconstructing the sample from the second coded information when the sample is located out of the region of interest.

9. The method of claim 6, wherein the reconstructing comprises:
determining a first sub-sample value of a sample in the reconstructed picture according to the first coded information;
determining a second sub-sample value of the sample in the reconstructed picture according to the second coded information of the second layer; and
reconstructing the sample according to an addition of the first sub-sample value and the second sub-sample value.

10. The method of claim 1, wherein the reconstructing comprises:
reconstructing a first picture corresponding to a first coded picture in the first coded pictures of the first layer according to the first coded information; and
reconstructing, using an inter-layer prediction, one or more samples of a second coded picture in the second layer based on at least a first sample in the first picture of the first layer.

11. The method of claim 10 wherein the first picture comprises a portion that is labeled as a region of interest, and the reconstructing the one or more samples of the second coded picture comprises:
reconstructing a block of the second coded picture according to a refence block that is within the portion labeled as the region of interest.

12. The method of claim 10, wherein the first picture comprises a portion that is labeled as region of interest, and the method comprises:
determining that a reference block candidate for the one or more samples is in the first picture and is located outside of the portion; and
excluding the reference block candidate for the inter-layer prediction.

13. The method of claim 10, wherein the first picture comprises a portion that is labeled as region of interest, and the method comprises:
determining a motion vector for the one or more samples of the second coded picture based on a motion vector predictor located in the portion of the first picture.

14. The method of claim 13, further comprising:
determining that a temporal motion vector prediction (TMVP) candidate of the first picture for the motion vector predictor is located out of the portion labeled as the region of interest; and
excluding the TMVP candidate to be the motion vector predictor.

15. The method of claim 14, further comprising:
determining that a temporal motion vector prediction (TMVP) candidate of the first picture for the motion vector predictor is located out of the portion labeled as the region of interest; and
determining a substitute TMVP candidate in the portion labeled as the region of interest to be the motion vector predictor for the one or more samples of the second coded picture.

16. The method of claim 13, further comprising:
performing a subblock based temporal motion vector prediction (SbTMVP) to determine motion vectors for samples in a second subblock of the second coded picture based on a SbTMVP candidate in the first picture when the SbTMVP candidate is located within the portion labeled as the region of interest.

17. The method of claim 13, further comprising:
determining that a subblock based temporal motion vector prediction (SbTMVP) candidate in the first picture for predicting motion vectors of samples in a second subblock of the second coded picture includes at least a first sample located out of the portion labeled as the region of interest;
padding at least the first sample in the SbTMVP candidate with a motion vector of a second sample that is located within the portion labeled as the region of interest; and
determining the motion vectors of the samples in the second subblock of the second coded picture based on the SbTMVP candidate.

18. The method of claim 10, wherein the first coded information comprises coded information with a different truncated bit depth from the second coded information, and method comprises:
performing a reverse bit depth truncation on at least the first sample in the first picture of the first layer to generate at least a restored first sample; and
reconstructing, using the inter-layer prediction, the one or more samples of the second coded picture in the second layer based on at least the restored first sample in the first picture.

19. A method of video encoding, comprising:
generating first coded information corresponding to first coded pictures of a first layer using a multi-layer coding on a video, the first layer serving for a machine task;
generating second coded information corresponding to second coded pictures of a second layer using the multi-layer coding on the video, the second layer serving for a human consumption; and
generating a coded video bitstream for the video, the coded video bitstream including at least the first coded information and the second coded information.

20. A method of video processing, the method comprising:
processing a bitstream of video data according to a format rule, wherein:
the bitstream includes coded information of a video using multi-layer coding, the coded information comprises first coded information corresponding to first coded pictures of a first layer serving for a machine task, and second coded information corresponding to second coded pictures of a second layer serving for a human consumption; and
the format rule specifies that:
a consumption type is determined from at least the machine task and the human consumption; and
based on the consumption type, at least a reconstructed picture is reconstructed according to at least one of the first coded information and/or the second coded information.
